(19) United States
(12) Patent Application Publication
(10) Pub. No.: US 2012/0094086 A1
(43) Pub. Date: Apr. 19, 2012

(54) EMBOSSED CARRIER TAPE AND METHOD OF PRODUCTION THEREOF

(75) Inventors: Atsushi Takei, Gunma (JP); Takenobu Sasakawa, Kanagawa (JP); Yasushi Hirokawa, Gunma (JP); Takashi Hatsuku, Kanagawa (JP)

(73) Assignee: DENKI KAGAKU KOGYO KABUSHIKI KAISHA, Tokyo (JP)

(21) Appl. No.: 13/378,378

(22) PCT Filed: Jun. 10, 2010
(86) PCT No.: PCT/JP2010/059824

§ 371 Date: Dec. 15, 2011

(30) Foreign Application Priority Data
Jun. 16, 2009 (JP) 2009-142996
Jun. 22, 2009 (JP) 2009-147403

(51) Int. Cl. B32B 3/28; B32B 3/30; B32B 27/28

(52) U.S. Cl. 428/179; 493/339; 428/174

(57) ABSTRACT

Provided are an embossed carrier tape having an embossed portion which is excellent in transparency and which has a high shape accuracy and a high buckling strength, and a method of production of the embossed carrier tape. The method of production of an embossed carrier tape comprises (a) a step of slitting a sheet which is obtained by biaxially stretching a styrene-based resin composition and which has an orientation relaxation stress of 0.2 to 0.8 MPa, measured in accordance with ASTM D-1504, into a tape-like form, (b) a step of heating only the reason of the slit tape where the embossed portion is to be formed, and (c) a step of forming an embossed portion in the heated area. Also, an embossed carrier tape manufactured by the method of production is provided.

### TECHNICAL FIELD

The present invention relates to an embossed carrier tape for electronic components, and a method of production of said carrier tape.

### BACKGROUND ART

Conventionally, embossed carrier tapes formed of sheets of thermoplastic resins such as vinyl chloride resins, styrene resins, polyethylene terephthalate resins and polycarbonate resins, and embossed by thermoforming, have been used as carrier tapes for housing electronic components to be mounted on electronic devices.

In such embossed carrier tapes, measures must be taken to prevent electrostatic damage to the electronic components. For example, for electronic components requiring a high degree of anti-static protection such as ICs and LSI, sheets consisting of resin compositions containing conductive fillers such as carbon black in the thermoplastic resins mentioned above or sheets having conductive coatings or the like applied to the surfaces of resin sheets as mentioned above are used. These are generally opaque.

On the other hand, in embossed carrier tapes for housing electronic components such as connectors that are not easily susceptible to destruction by electrostatic damage, transparent type embossed carrier tapes having thermoplastic resins of relatively high transparency among the above-described resins as base materials have been conventionally used due to the advantages of being able to observe the contained electronic components in detail from the outside by eye or using inspection devices, or enabling text written on the components to be detected, and demand for such carrier tapes is rising.

Furthermore, due to advances in size reduction of electronic components, these transparent types of carrier tape are increasingly required to have tiny embossed portions (also known as electronic component pockets or cavities) that are thin and excel in shape precision and buckling strength in addition to the transparency mentioned above.

Among such sheets for transparent type embossed carrier tapes, examples of styrene resin sheets include sheets obtained by mixing general-purpose polystyrene resins with styrene-butadiene block copolymers (see Patent Documents 1 and 2) and sheets consisting of rubber-modified styrene polymers comprising styrene monomer units and (meth)acrylic acid ester monomer units (see Patent Documents 3 and 4) are known.

Examples of methods of forming such sheets include press forming, vacuum forming, compressed-air forming and rotary vacuum forming, but whatever forming method is used, it is invariably difficult to obtain small embossed portions excelling in transparency, shape precision and buckling strength as mentioned above.
Patent Document 1: JP 2002-332392 A
Patent Document 2: JP 2003-055526 A
Patent Document 3: JP H10-279755 A
Patent Document 4: JP 2003-253069 A

### SUMMARY OF THE INVENTION

The present invention addresses the problem of offering an embossed carrier tape with good transparency and having embossed portions excelling in shape precision and buckling strength, and a method of production thereof.

The method of producing an embossed carrier tape, comprising steps of:

(a) slitting a sheet formed by biaxially stretching a styrene resin composition, having an orientation relaxation stress of 0.2 to 0.8 MPa measured in accordance with ASTM D-1504, into tape form;

(b) heating only areas of the slitted tape on which embossed portions are to be formed; and

(c) forming embossed portions at the heated areas.

The embossed carrier tape obtained by the method of production of an embossed carrier tape consisting of the above features has good transparency, and excels in shape precision and buckling strength.

According to an embodiment of the present invention, step (c) comprises forming the embossed portions by press-forming the heated areas.

In this embodiment, the sheet is a biaxially stretched sheet of thickness 0.15 to 0.5 mm, and step (b) comprises locally heating tape composed of a biaxially stretched sheet of sheet thickness 0.15 to 0.5 mm by bringing it into contact, for 0.3 to 5.0 seconds, with local heating portions heated to 100 to 180° C. having contact surfaces of shapes corresponding to the areas where the embossed portions are to be formed. Additionally, step (b) comprises positioning the tape between a pair of opposing local heating portions, such that the spacing between the contact surfaces of the opposing local heating portions is 95 to 100% of the sheet thickness. Furthermore, the surface area of the contact surfaces of the local heating portions is 90 to 110% of the surface area of the areas where the embossed portions are to be formed.

In another embodiment of the present invention, step (b) comprises consecutively heating only areas of the slitted tape where embossed portions are to be formed, using a rotating cylindrical heater, and step (c) comprises consecutively forming the embossed portions at the heated areas using a cylindrical rotary vacuum forming mold.

In this embodiment, steps (b) and (c) preferably comprise rotating, in synchronization, a cylindrical heater having local heating portions for heating areas of the tape where the embossed portions are to be formed disposed on the outer circumference of a cylinder, in order to form the embossed portions at the heated areas of the tape; and a cylindrical rotary vacuum forming mold having embossment forming portions disposed on an outer circumference of the cylinder, where the tape is subjected to evacuation to form embossed portions.

Additionally, the tape should preferably be composed of a biaxially stretched sheet with a sheet thickness of 0.15 to 0.5 mm slitted into tape form, heated by bringing it into contact, for 0.5 to 5.0 seconds, with local heating portions of a heater at 110 to 180° C. having contact surfaces of shapes corresponding to the areas where the embossed portions are to be formed. Furthermore, the surface area of the contact surfaces should preferably be 90 to 120% of the surface area of the areas where the embossed portions are to be formed.

According to the present invention, the styrene resin composition comprises 7 to 79.5 mass % of a polystyrene resin (A); 0.5 to 3 mass % of a high-impact polystyrene resin (B) comprising 4 to 10 mass % of a rubber component; and 20 to 90 mass % of a styrene-conjugated diene block copolymer (C) wherein the molecular weight of the styrene block portion is at least 10,000 and less than 130,000.

According to the present invention, the styrene-conjugated block copolymer (C) should preferably be a copolymer comprising 70 to 90 mass % styrene and 10 to 30 mass % conjugated diene.

Additionally, the present invention offers an embossed carrier tape formed by slitting a sheet formed by biaxially stretching a styrene resin composition, having an orientation relaxation stress of 0.2 to 0.8 MPa measured in accordance with ASTM D-1504, into tape form; heating only areas of the slitted tape on which embossed portions are to be formed; then forming embossed portions.

The embossed carrier tape of the above constitution has good transparency, and has embossed portions excelling in shape precision and buckling strength.

Additionally, according to an embodiment of the present invention, the embossed carrier tape has embossed portions formed by press-forming.

In this embodiment, the sheet should be a biaxially stretched sheet with a sheet thickness of 0.15 to 0.5 mm, heated by bringing it into contact, for 0.3 to 5.0 seconds, with local heating portions of a heater at 100 to 180° C. having contact surfaces of shapes corresponding to the areas where the embossed portions are to be formed. Additionally, the tape should be positioned between a pair of opposing local heating portions, such that the spacing between the contact surfaces of the opposing local heating portions is 95 to 100% of the sheet thickness. Additionally, the surface area of the contact surfaces of the local heating portions should be 90 to 110% of the surface area of the areas where the embossed portions are to be formed.

According to another embodiment of the present invention, only areas of the slitted tape where embossed portions are to be formed are consecutively heated using a rotating cylindrical heater, and the embossed portions are consecutively formed at the heated areas using a cylindrical rotary vacuum forming mold.

In this embodiment, it is preferable to rotate, in synchronization, a cylindrical heater having local heating portions for heating areas of the tape where the embossed portions are to be formed disposed on the outer circumference of a cylinder, in order to form the embossed portions at the heated areas of the tape; and a cylindrical rotary vacuum forming mold having embossment forming portions disposed on an outer circumference of the cylinder, where the tape is subjected to evacuation to form embossed portions.

Additionally, the tape should preferably be composed of a biaxially stretched sheet with a sheet thickness of 0.15 to 0.5 mm slitted into tape form, heated by bringing it into contact, for 0.5 to 5.0 seconds, with local heating portions of a heater at 110 to 180° C. having contact surfaces of shapes corresponding to the areas where the embossed portions are to be formed. Furthermore, the surface area of the contact surfaces should preferably be 90 to 120% of the surface area of the areas where the embossed portions are to be formed.

According to the present invention, the embossed carrier tape is such that the styrene resin composition comprises 7 to 79.5 mass % of a polystyrene resin (A); 0.5 to 3 mass % of a high-impact polystyrene resin (B) comprising 4 to 10 mass % of a rubber component; and 20 to 90 mass % of a styrene-conjugated diene block copolymer (C) wherein the molecular weight of the styrene block portion is at least 10,000 and less than 130,000.

Additionally, according to the present invention, the styrene-conjugated diene block copolymer (C) is a copolymer comprising 70 to 90 mass % styrene and 10 to 30 mass % conjugated diene.

The present invention offers an embossed carrier tape with good transparency and having embossed portions excelling in shape precision and buckling strength, and a method of production thereof.

### BRIEF DESCRIPTION OF THE DRAWINGS

FIG. 1 A schematic view for explaining a method of production of an embossed carrier tape according to Embodiment 1.

FIG. 2 A schematic view for explaining a method of production of an embossed carrier tape according to Embodiment 2.

FIG. 3 A schematic view for explaining a method of production of an embossed carrier tape according to Embodiment 2.

### DESCRIPTION OF REFERENCE NUMBERS

1 tape
2 heater
3 press mold
4 contact surface
5 local heating portion
6 embossed carrier tape
7 tape
8 heater
9 rotary vacuum forming mold
10 contact surface
11 local heating portion
12 embossment molding portion
13 rotation synchronizing device
14 embossed carrier tape

### MODES FOR CARRYING OUT THE INVENTION

Herebelow, embodiments for carrying out the present invention shall be explained with reference to the drawings.

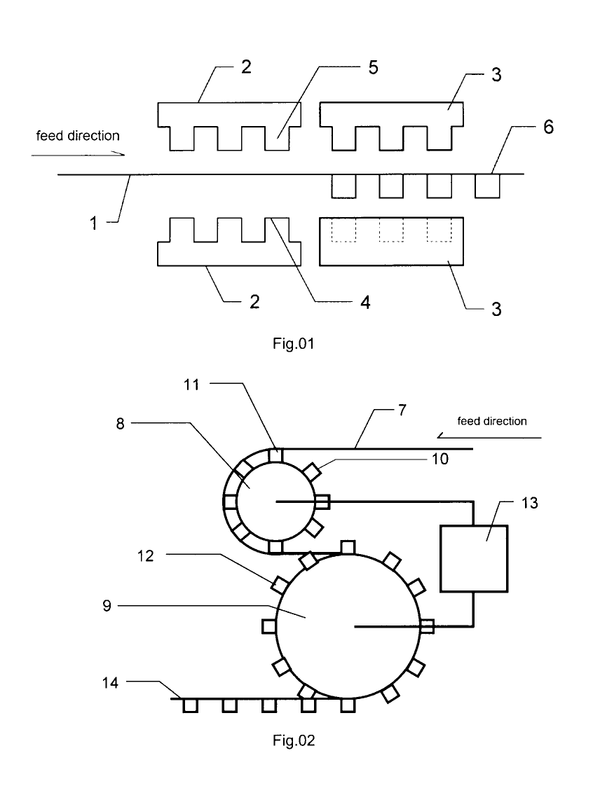

FIG. 1 schematically shows a method of production for an embossed carrier tape when forming the embossed portions by press forming (hereinafter referred to as “Embodiment 1”).

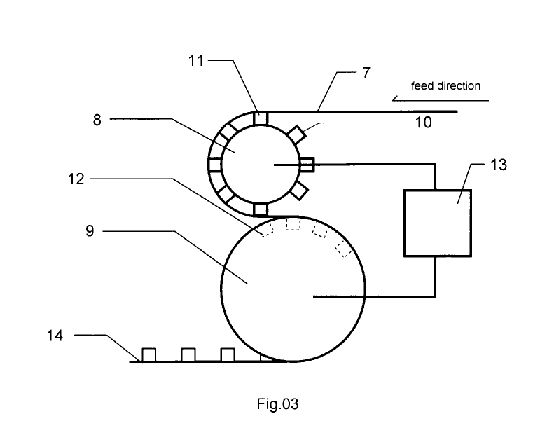

FIGS. 2 and 3 schematically show a method of production for an embossed carrier type when forming the embossed portions by rotary vacuum forming (hereinafter referred to as “Embodiment 2”).

### Embodiment 1

In Embodiment 1, a sheet obtained by biaxially stretching a styrene resin composition is used.

Here, styrene resins refer to homopolymers or copolymers composed of styrene monomers, including various resins such as general purpose polystyrene resins (hereinafter referred to as “GPPS resins”), high-impact polystyrene resins (hereinafter referred to as “HIPS resins”), styrene-conjugated diene block copolymers and styrene-(meth)acrylic acid ester copolymers, and mixtures of one or more thereof.

A typical example of the blend of styrene resin compositions constituting a sheet is a mixture of GPPS resins and HIPS resins, or a mixture further adding a styrene-conjugated diene block copolymer thereto.

GPPS resins (A) are resins composed basically of styrene units, and while not particularly limited, the weight-average molecular weight should, for example, be 200,000 to 400,000, preferably 220,000 to 350,000, more preferably 220,000 to 260,000 by polystyrene equivalent as measured by gel permeation chromatography, in order to maintain the strength and transparency of the embossed carrier tape.

Additionally, HIPS (B) are resins known generally as “high-impact polystyrene resins” as described above, examples of which are those that are formed by graft polymerization of styrenes in the presence of rubber such as diene rubber.

In terms of the transparency and strength, the rubber should be present at 4-10 mass % with respect to 100 mass % of HIPS, and the rubber particle size should be 0.5 to 4 μm. Furthermore, the resin fluidity should preferably have excellent fluidity of at last 5 g/10 min. More preferably, the resin fluidity is 5 to 10 g/10 min. The rubber particle size refers to the rubber particle size by a volume standard, and the fluidity is the value measured in accordance with JIS K7210.

The styrene-conjugated diene block copolymer (C) is an optional resin component as indicated above, and is a polymer comprising a polymer block composed mainly of styrene monomers and a polymer block composed mainly of conjugated diene monomers.

Examples of styrene monomers include styrene, o-methylstyrene, p-methylstyrene, p-tert-butylstyrene, 1,3-dimethylstyrene, α-methylstyrene, vinylnaphthalene, vinylanthracene and 1,1-diphenylethylene, among which styrene is preferred. One or more types of styrenes may be used.

Conjugated diene monomers are compounds having conjugated double bonds in their structure, examples of which include 1,3-butadiene (butadiene), 2-methyl-1,3-butadiene (isoprene), 2,3-dimethyl-1,3-butadiene, 1,3-pentadiene, 1,3-hexadiene and 2-methylpentadiene, among which butadiene and isoprene are preferred. One or more types of conjugated diene monomers may be used.

One or more types of styrene-conjugated diene block copolymers may be used, of which those that are commercially available may be used as is. Among styrene-conjugated diene block copolymers, styrene-butadiene block copolymers are especially preferred.

Additionally, as the block structure of the styrene-conjugated diene block copolymer (C), styrene-conjugated diene block copolymers of various block structures may be used as long as they do not detract from the transparency or workability of the embossed carrier tape. Those with a styrene content of 70 to 90 mass %, a butadiene content of 10 to 30 mass %, and a molecular weight of 10,000 to 130,000 for the styrene block portions are particularly preferred for the transparency and strength of the embossed carrier tapes and suppression of dust during the slitting process, punching process and hole forming process.

As long as the molecular weight of the styrene block portion is at least 10,000, the embossed carrier tape will have good transparency and the appearance of the molded articles will not be degraded. Additionally, if the molecular weight of the styrene block portion is 130,000 or less, then it will have good fluidity during the extrusion molding process, providing high moldability without the need to raise the extrusion temperature to a high temperature. Furthermore, since there is no need for high-temperature extrusion, the stretching temperature is low, and an embossed carrier tape with good strength can be obtained.

The molecular weight of the styrene block portion in the present invention is the molecular weight determined from a calibration curve prepared using standard polystyrenes and styrene oligomers for the molecular weights corresponding to the respective peaks in GPC measurements (using a UV spectrometer set to a wavelength of 254 nm) for vinyl aromatic hydrocarbon polymer components obtained by ozonolysis of block copolymers (the method described in Y. Tanaka et al., Rubber Chemistry and Technology, 59, 16, 1986).

In the block copolymers containing a plurality of styrene block portions of different molecular weight, there will be a plurality of molecular weights for the styrene block portions depending on the block. In that case, it is sufficient for either of the styrene block portions to have a molecular weight of 10,000 to 130,000, though preferable for all of the styrene block portions to have a molecular weight of 10,000 to 130,000.

If the GPPS (A) content of the styrene resin composition is at least 7 mass %, then the sheet will have a high tensile elasticity, and there will be sufficient buckling strength in the embossed portions when formed into a carrier tape. The GPPS (A) content is preferably 7 to 79.5 mass %, more preferably 7 to 59.5 mass %. By setting the GPPS (A) content in this range, the dust generated during the hole forming process performed when forming this sheet into a carrier tape and when slitting the sheet into tape form can be kept low.

The HIPS (B) content is preferably at least 0.5 mass % at minimum for lubricity of the surface of the embossed carrier tape, and is preferably at most 3 mass % at maximum for transparency and strength. Preferably, in order to achieve good transparency, the HIPS (B) content is 0.5 to 2 mass %.

On the other hand, the styrene-conjugated diene block copolymer (C) is an optional resin component which does not need to be added, but if the amount of GPPS (A) and HIPS (B) needs to be reduced, then it can be added in an amount of up to 90 mass % at maximum. The styrene-conjugated diene block copolymer (C) content is preferably 20 to 90 mass %, and more preferably 40 to 90 mass %.

Accordingly, the styrene resin composition constituting the sheet preferably contains 7 to 79.5 mass % of GPPS (A), 0.5 to 3 mass % of HIPS (B) containing 4 to 10 mass % of rubber, and 20 to 90 mass % of a styrene-conjugated diene block copolymer (C) wherein the styrene block portions have a molecular weight of 10,000 to 130,000.

Additionally, various additives, for example, stabilizers (phosphorus, sulfur or hindered phenol type oxidants, UV absorbers, thermostabilizers, etc.), plasticizers (mineral oils etc.), antistatic agents, lubricants (stearic acid, fatty acid esters, etc.) and mold release agents may be added to the styrene resin composition within a range such as not to detract from the purpose of the present invention. Inorganic particles (calcium phosphate, barium sulfate, talc, zeolite, silica, etc.) may be further added.

A biaxially stretched sheet composed of the above styrene resin composition may be produced by a conventionally used method. For example, a styrene resin composition may be extruded by an extruder, melt-kneaded (e.g., kneaded at a temperature of 170 to 240° C.), extruded from a die (especially a T-die), then consecutively or simultaneously stretched 1.5 to 5-fold, preferably 1.5 to 4-fold and more preferably 2 to 3-fold in two axial directions at a temperature, for example, of 85 to 135° C.

If the stretching rate is at least 1.5-fold, the embossed carrier tape will have good strength, especially robustness, and if 5-fold or less, disparities in the thickness of the containers formed in thermoforming processes such as vacuum forming and compressed-air forming can be suppressed. For this reason, it is preferable to keep the stretching rate 5-fold or less, and to obtain a biaxially stretched sheet that is roughly uniformly stretched over the entire sheet.

Examples of consecutive biaxial stretching methods include, for example, a method of stretching a base sheet formed by extrusion from a T-die or a calender 1.5- to 4-fold in one direction while heated to 90 to 135° C., then stretching 1.5- to 4-fold in a direction perpendicular to the aforementioned axial direction while heated to 90 to 135° C.

The orientation release stress of a biaxially stretched sheet for use in carrier tape obtained as described above is 0.2 to 0.8 MPa, preferably 0.3 to 0.6 MPa based on the orientation release stress (contraction stress at 130° C.) measured in compliance with ASTM D-1504. Sufficient transparency can be obtained if the orientation release stress is at least 0.2 MPa, and the sheet can be easily formed into a carrier tape if 0.8 MPa or less.

While the orientation release stress will change depending on the composition of the styrene resin composition used and conditions such as the stretching temperature and the stretching rate, a sheet having a predetermined orientation release stress (contraction stress) can be obtained by adjusting these conditions.

Additionally, the thickness of a biaxially stretched sheet for use in carrier tape obtained as mentioned above is in the range of 0.15 to 0.5 mm, preferably 0.16 to 0.4 mm, more preferably 0.18 to 0.3 mm with a view to the transparency, strength, formability, dust suppression and burr suppression effects of the sheet.

The biaxially stretched sheet may be a single layer or may consist of plural layers. For example, a biaxially stretched sheet having plural layers may be produced by heat lamination wherein resin compositions used for each constituent layer are formed by a plurality of extruders, and the resulting sheets are stacked and heated to integrate them, or it may be produced by coextruding the resin compositions for use in the constituent layers using a general-purpose die equipped with a feed block or a multi-manifold die. Coextrusion is preferable for providing a thin surface layer and excelling in mass producibility. A biaxially stretched laminated sheet can be obtained by using a method described above to biaxially stretch a sheet laminated in this way.

Additionally, the biaxially stretched sheet can be coated with a surface treating agent such as a mold release agent or antistatic agent, subjected to a drying process, then wound onto a roll. Before coating with a surface treating agent, a corona treatment or the like should be performed in order to raise the wettability of the surface treating agent. Additionally, an antistatic agent can be added to the resin composition to perform an antistatic treatment.

The method of producing an embossed carrier tape according to Embodiment 1 comprises steps of (a) slitting the resulting biaxially stretched sheet into tape form, (b) locally heating only areas of the slitted tape where embossed portions are to be formed, and (c) forming the embossed portions by press-molding the locally heated areas.

As shown in FIG. 1, the tape 1 formed by slitting a biaxially stretched sheet is heated by a heater 2, then subjected to a press mold 3 to form the embossed portions. The heater 2 has local heating portions 5 with contact surfaces 4 in shapes corresponding to the areas in which the embossed portions are formed, whereby the tape 1 is locally heated and the heated areas form embossed portions, enabling a highly precise embossed carrier tape 6 to be formed.

The tape 1 composed of the biaxially stretched sheet is fed to the heater 2 little by little. The tape feeding structure may be achieved by winding such as on a reel or the like, or may be conveyed by feeding holes provided on both sides, or one side in the longitudinal direction of the tape.

The number of local heating portions 5 in the heater 2 will depend on the size of the embossed portions, but for example, if the size of the embossed portions is about 10 mm in the longitudinal direction of the tape, then 3 to 12 of them should be provided for each heater. In that case, the size of the heater 2 in the longitudinal direction of the tape will be about 50 to 200 mm. In this range, the tape can be delivered to the subsequent embossed portion forming step efficiently and before the temperature of the tape falls after heating.

In the embossed portion forming step, embossed portions are formed by sandwiching the tape 1 in a press mold 3. The press mold 3 has convex portions/concave portions in the same number and spacing as the local heating portions 5 of the heater 2 to enable all the areas heated in a single pass through the heater 2 to be embossed in a single pressing. While depending on the size of the embossed portions, disparities in the forming precision can be reduced by forming the embossed portions in units of 3 to 12, as long as the size in the longitudinal direction of the tape is about 10 mm.

The forming precision can be improved by evacuating the insides of the concavities in the press mold as an aid during press forming. Additionally, even without forming a vacuum, the forming precision can be similarly improved by providing a structure such as slits enabling the air inside the concavities in the press mold to escape outside the press mold. Furthermore, the formation of embossed portions by press forming may be followed by a cooling step.

According to the present embodiment, the portions of the tape on which the embossed portions are formed are locally heated at a predetermined temperature for a predetermined time, then press formed to form embossed portions as pockets for housing compact electronic components consecutively in the longitudinal direction of the tape.

In general, biaxially stretched sheets composed of styrene resin compositions tend to undergo thermal contraction during thermoforming as described above, so they have not been used when requiring high precision such as in carrier tape. However, by locally heating only the areas where the embossed portions of the embossed carrier tape are to be formed as in the production method of the present embodiment, the high precision molding that is required of carrier tape can be achieved. Here, the areas in which the embossed portions are formed correspond to the mouth portions of the embossed portions of the embossed carrier tape formed by press forming.

The heater 2 used for heating has a shape corresponding to the areas where the embossed portions of the embossed carrier tape are formed, in other words, protruding portions having contact surfaces 4 in shapes roughly complementary to the mouth portions of the embossed portions, that is, the local heating portions 5.

By locally heating the tape 1 composed of a biaxially stretched sheet by means of a heater 2 comprising local heating portions 5 in this way, the highly precise molding required of carrier tape can be achieved. When the entire surface of the tape 1 is heated by a heater 2 not having such local heating portions 5, tape composed of biaxially stretched styrene resin sheets will tend to thermally contract, making it difficult to achieve the highly precise molding required in carrier tape.

The local heating should preferably be performed in a predetermined surface area corresponding to the areas in which the embossed portions are formed. For this reason, the contact surfaces 4 of the local heating portions 5 should preferably have shapes roughly complementary to the shapes of the mouth portions of the embossed portions, and in Embodiment 1 which uses press forming, occupy 90% to 110% of the surface area, preferably 95% to 108% of the surface area, and more preferably 98% to 105% of the surface area with respect to the surface area of the mouth portions, enabling the highly precise forming that is required in carrier tape.

As long as the surface area of the contact surface 4 is at least 90%, the range of heating will be sufficient for molding, and an embossed portion of the desired shape will be formed. Additionally, as long as the surface area of the contact surface 4 is 110% or less, then the above-mentioned thermal contraction will be suppressed, enabling the highly precise forming that is required of carrier tape.

The heating by the heater 2 having local heating portions 5 should be performed at a predetermined heating temperature and time according to the thickness of the biaxially stretched sheet, to obtain an embossed carrier tape with good formability. In Embodiment 1 which uses press forming, the heater 2 which has been heated to 100 to 180° C. should be brought into contact with the tape 1 for 0.3 to 0.5 seconds for heating.

If the heating by the heater 2 is at least 100° C., the tape can be formed with sufficient flexibility for press forming, and at 180° C. or less, fusion of the tape 1 to the heater 2 can be avoided.

The contact heating time of the contact surface 4 to the tape 1 is such that the optimal value will differ depending on the thickness of the biaxially stretched sheet and the heating temperature. Generally, the heating time will be longer if the sheet thickness is greater and the heating time will be longer if the heating temperature is lower, so it should be adjusted while observing the molding condition. Additionally, if the heating time is 5 seconds or less, then portions other than the local heating portions 5 will not be heated by heat radiated from the heater 2, thereby preventing thermal contraction of the tape 1.

The heating of the tape 1 using the heater 2 should be performed from both sides of the tape 1 as shown in FIG. 1. By doing so, the temperature distribution in the thickness direction of the tape 1 can be reduced, and the heating time until the embossed portion can be formed into the desired shape can be shortened, so that the time required for heat due to radiation from the heater 2 to reach portions other than the portions where the embossed portions are to be formed will be shortened, as a result of which defects due to thermal contraction as mentioned above can be reduced.

Additionally, when heating the tape 1 by the heater from both sides, the gap (spacing) between the opposing contact surfaces 4 of the pair of heaters sandwiching the tape 1 should preferably be 95% to 100% of the sheet thickness.

When the gap between the opposing contact surfaces 4 of the heaters 2 sandwiching the tape 1 is greater than 95%, the melted sheet will not bulge out, thus avoiding defects in which the tape 1 becomes locally thick. Such locally thick portions are undesirable because they will remain after formation of the embossed portions, and can cause problems such as packaging defects due to electronic components being caught when packaging them into the electronic component housing pockets (embossed portions). Additionally, when the gap between the opposing contact surfaces 4 of the heater 2 when sandwiching the tape 1 is smaller than 100%, there is adequate contact between the tape 1 and the heater 2, thus providing an adequate heating efficiency and allowing for heating in a short time, as a result of which the above-mentioned thermal contraction can be suppressed to yield a highly precise embossed carrier tape 6.

Furthermore, after the tape 1 has been heated by the heater 2, it is quickly press-formed by a press mold 3, and the temperature of the press mold should preferably be in the range of 40° C. to 100° C. As long as the temperature of the press mold 3 is at least 40° C., the temperature of the tape 1 will not drop during press forming, and sufficient flexibility can be maintained for press-forming. Additionally, if the temperature of the press mold 3 is 100° C. or less, then post-contraction of the embossed carrier tape 6, including the embossed portions, can be prevented from occurring after removing the embossed carrier tape 6 from the press mold 3 after press forming.

### Embodiment 2

Next, Embodiment 2 of the method of producing an embossed carrier tape according to the present invention shall be explained with reference to FIG. 2 and FIG. 3. Embodiment 2 mainly differs from Embodiment 1 in that a cylindrical heater is used, and in that the embossed portions are formed by a rotary vacuum forming mold 9.

The explanations of features of Embodiment 2 that are the same as those in Embodiment 1 shall be omitted.

The method of production of the embossed carrier tape according to Embodiment 2 involves using a biaxially stretched sheet as in Embodiment 1, and comprises steps of (a) slitting the sheet into tape form, (b), continuously heating only the areas of the slit tape where the embossed portions are to be formed using a rotating cylindrical heater, and (c) continuously forming the embossed portions at the heated areas by means of a rotating cylindrical rotary vacuum forming mold.

That is, as shown in FIGS. 2 and 3, the tape 7 formed by slitting a biaxially stretched sheet is heated by a cylindrical heater 8, then rotary vacuum-formed with a cylindrical rotary vacuum forming mold 9 to form the embossed portions. More specifically, the cylindrical heater 8 has local heating portions 11 having contact surfaces 10 in shapes corresponding to the areas where the embossed portions are to be formed, positioned along the outer circumference of the cylinder. By rotating the heater 8, the tape 7 is locally and continuously heated, then the heated areas are vacuum-drawn by embossment molding portions 12 positioned along the outer circumference of the cylinder of the cylindrical rotary vacuum forming mold 9, thereby forming a highly precise embossed carrier tape 14.

The tape 7 consisting of a biaxially stretched sheet is continuously fed to the heater 8 and the rotary vacuum forming mold 9. The feeding structure for the tape 7 may be by winding on a reel or the like, or the tape may be conveyed by feeding holes provided on both sides, or one side in the longitudinal direction of the tape. A rotation synchronizing device 13 should make adjustments to position the embossment forming portions 12 at the locally heated areas of the tape 7.

In the present Embodiment 2 which uses rotary vacuum forming, the areas of the contact surfaces 10 where the local heating portions 11 of the heater 8 contact the tape 7 may depend on the size of the embossed portions, but they will be of roughly the same shape as the mouth surfaces of the embossed portions, and be in the range of 90% to 120%, preferably 95% to 118%, more preferably 98% to 115% of the surface area of the embossed mouths. In this range, it is possible to obtain an embossed carrier tape 14 having embossed portions excelling in shape precision and bending strength.

Additionally, the contact surfaces 10 of the local heating portions 11 that contact the tape 7 are preferably flat, or provided with a curved shape concentric with the heater 8.

During the embossed portion forming step, as shown in FIG. 2, the insides of embossment forming portions 12 (insides of concavities) that are recessed radially inward so that the mouth portions will face outward on the outer circumference of the cylinder of the rotary vacuum forming mold 9 are evacuated, thereby drawing the heated areas of the tape 7 into the concavities to form the embossed portions.

Alternatively, the embossed portions may be formed by evacuating the insides of embossment forming portions 12 (insides of concavities) that are recessed radially outward so that the mouth portions will face inward on the outer circumference of the cylinder of the rotary vacuum forming mold 9, thereby forming the heated portions of the tape 7 in the vicinity of the embossment forming portions 10, as shown in FIG. 3. The formation of the embossed portions by rotary vacuum forming may be followed by a cooling step.

In the embossed carrier tape of Embodiment 2, embossed portions for housing compact electronic components consecutively in the longitudinal direction of the tape can be formed by slitting the above-described biaxially stretched sheet for carrier tape into thin strips of tape, locally heating the areas of the tape where the embossed portions are to be formed to a predetermined temperature for a predetermined time, then rotary vacuum forming.

Conventional rotary vacuum forming is largely characterized by the fact that the same molding occurs at each revolution of the rotating drum, so errors are not cumulative over consecutive cavities or sprockets, making it suitable for forming embossed carrier tapes requiring a high degree of precision, but the biaxially stretched styrene resin sheet used in the present invention tends to undergo thermal contraction during thermoforming as indicated above, and for that reason, it has not previously been used for molding applications requiring high degrees of precision such as carrier tapes.

However, molding with the high degree of precision required in carrier tape is possible by locally heating only the areas of the embossed carrier tape where the embossed portions are to be formed. The areas where the embossed portions are to be formed correspond to the mouth portions of the embossed portions of the embossed carrier tape formed by vacuum forming.

The heater 8 used for heating is cylindrical, having local heating portions 11 having contact surfaces 10 roughly similar to the shapes of the mouth portions of the embossed portions of the embossed carrier tape on the outer circumference thereof, the contact surfaces 10 of the local heating portions 11 being flat or curved concentrically with the cylindrical heater 8.

By locally heating a tape 7 consisting of a biaxially stretched sheet using a heater 8 provided with a local heating portion 11 in this way, it is possible to achieve forming with the high degree of precision required of carrier tape. When tape is heated over its entire surface using a heater not having such local heating portions, tapes composed of biaxially stretched styrene resin sheets tend to thermally contract, making it difficult to achieve the high-precision molding that is required of carrier tape.

Local heating is preferably performed over predetermined surface areas corresponding to the areas where the embossed portions are formed. For this reason, in Embodiment 2 which uses rotary vacuum forming, the contact surfaces 10 of the local heating portions, when having shapes similar to the shapes of the mouth portions, have surface areas in the range of 90% to 120%, preferably 95% to 118%, more preferably 98% to 115% when the surface area occupied by the shape of the mouth portions is assumed to be 100%.

As long as the surface area of the contact surface 10 is at least 90%, the heated range is sufficient for forming, and the embossed portions can be formed in the desired shape. Additionally, as long as the surface area of the contact surfaces 10 is 120% or less, the above-mentioned thermal contraction is suppressed, enabling molding at the high degree of precision required in carrier tape.

The heating by the heaters 8 having local heating portions 11 is preferably performed by adjusting to a predetermined heating temperature and time with respect to the thickness of the biaxially stretched sheet. In the present Embodiment 2 which uses rotary vacuum forming, heating should be performed by bringing the heater that has been heated to 110° C. to 180° C. into contact with the sheet for 0.5 to 5.0 seconds.

As long as the heater 8 provides heating to at least 110° C., the tape 7 can be formed with sufficient flexibility for rotary vacuum forming, and as long as the temperature is 180° C. or less, the tape 7 can be prevented from fusing to the heater 8.

The optimum values for the contact heating time of the contact surfaces 10 to the tape 7 will differ depending on the thickness of the biaxially stretched sheet and the heating temperature, the heating time needing to be generally longer when the sheet is thicker, and the heating time needing to be longer when the heating temperature is low, so that it must be adjusted while observing the molding condition. The contact heating time of the contact surfaces 10 with respect to the tape 7 can be set by adjusting the delivery speed of the tape 7, in other words, the rotation speed of the drum.

As long as the heating time of the tape 7 is at least 0.5 seconds, it is possible to apply sufficient heat for rotary vacuum forming in the thickness direction of the tape 7, providing sufficient flexibility for rotary vacuum forming of the tape 7, and enabling the embossed portions to be formed with high precision. Additionally, as long as the heating time is 5 seconds or less, heating of portions other than the local heating portions 11 due to radiated heat from the heater 8 can be suppressed, thus preventing thermal contraction.

The rotary vacuum forming mold 9 is cylindrical, having embossment forming portions 12 for forming embossed portions on the tape on the circumferential portions thereof. The rotary vacuum forming mold 9 may be a female-type mold arranged to be recessed in the radially inward direction so that the mouth portions will face outward on the outer circumference of the cylinder of the rotary vacuum forming mold 9 (FIG. 2), or a male-type mold arranged to be recessed in the radially outward direction so that the mouth portions will face inward on the outer circumference of the cylinder of the rotary vacuum forming mold 9 (FIG. 3).

The tape 7 that has been locally heated by the heater 8 is fed to the rotary vacuum forming mold 9, where the heated areas of the tape are aligned with the embossment forming portions 12, and the embossment forming portions 12 are evacuated to draw the tape into the roughly concave embossment forming portions, thereby forming the embossed portions.

Female-type molds are suitable for forming deep embossed portions. On the other hand, while male-type molds are not well-suited to formation of deep embossed portions, they are characterized by being capable of achieving a high degree of dimensional precision on the inner surfaces of the embossed portions (the side where the electronic components are to be housed).

Therefore, male-type molds are preferred for forming embossed portions for housing electronic components with a thickness of 1 mm or less, while female-type molds are preferred for forming embossed portions for housing larger electronic components.

After forming the embossed portions, the tape that has been locally heated by a temperature-controlled mold is cooled, and when the tape is separated from the mold, the shape of the formed embossed portions can be retained.

In order to maintain the shape of the embossment forming portions of the mold and in order to obtain a high thermal conductivity to improve the temperature control precision of the mold, the material of the mold should preferably be a metal such as aluminum, copper, iron, stainless steel or brass, but there is no limitation thereto as long as it is capable of maintaining the embossment forming portions of the mold and has thermal conductivity for improving the temperature control precision of the mold.

When separating the tape in which the embossed portions have been formed from the mold, it is possible to use a separating tool for assisting in separation. In this case, it is preferable to use a separation tool composed, for example, of a resin so as not to damage the mold and tape, but there is no limitation thereto. Additionally, while the shape of the separation tool may be roughly wedge-shaped so as to allow gradual separation of the tape from the mold, there is no limitation thereto.

Additionally, a roller may be brought into contact with the circumferential portions other than the embossment forming portions for the purposes of assisting in embossment formation. In that case, there are no restrictions on the size and number of rollers, and the material of the rollers is also not particularly restricted as long as they do not damage the tape. Additionally, the rollers may be temperature-controlled. The controlled temperatures of the rollers should be the same as the controlled temperatures of the mold.

In order to form the embossed portions in the locally heated areas of the tape 7, the cylindrical heater 8, on which local heating portions 11 for heating the areas of the tape 7 where the embossed portions are to be formed are disposed on the outer circumference of the cylinder, and the cylindrical rotary vacuum forming mold 9, on which embossment forming portions for evacuating the tape in the direction of the forming mold to form embossed portions are disposed on the outer circumference of the cylinder, are preferably rotated in synchronization.

While the method of synchronization is not particularly limited, there are methods of synchronization using gears, methods of synchronization using timing belts, and methods of controlling the rotation of the heater 8 based on signals obtained from a sensor (such as a rotary encoder) detecting the rotation of the rotary vacuum forming mold 9, and any such method may be used for synchronization.

Additionally, the diameter of the rotary vacuum forming mold 9 and the diameter of the heater 8 are not particularly limited as long as the combination of diameters can be synchronized.

Regarding the positioning of the rotary vacuum forming mold 9 and the heater 8, they must be as close together as possible in order to prevent the sheet 6 that has been heated by the heater 8 from cooling to a temperature at which rotary vacuum forming is not possible by the time it contacts the rotary vacuum forming mold 9 for vacuum forming.

If this is not possible, then some kind of arrangement should be made to prevent the tape 7 from cooling between the time when the heated sheet 6 leaves the heater 8 until it comes into contact with the rotary vacuum forming mold 9, such as by passing it through a tube surrounded by a thermal insulator or irradiating with an infrared heater.

Furthermore, after the heating of the tape 7 by the heater 8 is complete, it should be quickly subjected to rotary vacuum forming by the rotary vacuum forming mold 9, in which case the temperature of the rotary vacuum forming mold 9 should be in the range of 40° C. to 100° C.

As long as the temperature of the rotary vacuum forming mold is at least 40° C., the temperature of the tape 7 will not fall during rotary vacuum forming, and the tape 7 can be provided with sufficient flexibility for rotary vacuum forming. Additionally, as long as the temperature of the rotary vacuum forming mold 9 is 100° C. or less, post-contraction of the tape including the embossed portions can be suppressed after extracting the sheet which has been rotary vacuum formed in the rotary vacuum forming mold 9, thereby improving the high-precision formability that is required in embossed carrier tape 14.

The embossed carrier tape that is produced by the production methods of Embodiments 1 and 2 is produced from a styrene resin composition, and is therefore highly transparent. Therefore, differences in transparency due to differences in thickness of the molded portions and non-molded portions of the packaging container can be reduced, increasing the visibility of the contents. Additionally, since the resulting embossed carrier tape has a predetermined sheet thickness and orientation relaxation stress, it can be made thinner, and the generation of dust (resin dust) during sheet slitting and post-processing such as punching and hole formation of the molded products can be largely suppressed.

The surface of the resulting embossed carrier tape should preferably be subjected to an anti-static treatment when intended to house electronic components that are easily damaged by static electricity such as ICs. The anti-static treatment can be performed, for example, by applying an anti-static agent to the surface of the sheet for use in carrier tape.

While the electronic components to be housed in the carrier tape of the present invention are not particularly limited, examples include ICs, LEDs (light emitting diodes), resistors, liquid crystal, capacitors, transistors, piezoelectric resistors, filters, crystal oscillators, crystal vibrators, diodes, connectors, switches, volumes, relays and inductors. The format of the ICs is not particularly limited, and could, for example, be SOP, HEMT, SQFP, BGA, CSP, SOJ, QFP or PLCC.

While the carrier tape and production method thereof according to the present invention has been described with reference to embodiments thereof above, the present invention is not to be construed as being limited thereto.

### EXAMPLES

Herebelow, examples and comparative examples will be describe, but the present invention is not to be construed as being limited by these examples.

In Examples 1-22, Comparative Examples 1-7 and Experimental Examples 1-18, the following resins 1-6 were used as the styrene resins among the raw materials. Resin 1 is GPPS resin (A), Resin 2 is HIPS resin (B), Resins 3-5 are resins containing a styrene-conjugated diene block copolymer (C) and Resin 6 is a rubber-modified styrene polymer comprising a (meth)acrylic acid ester monomer unit (C).

Resin 1—GPPS resin of weight-average molecular weight 240,000 (Toyo Styrene Toyo Styrol GP HRM61)
Resin 2—HIPS resin with styrene/rubber mass ratio 95/5, rubber particle size 2.9 microns and fluidity 7.0 g/10 min (Toyo Styrene Toyo Styrol HI H370).
Resin 3—Resin comprising styrene-butadiene block copolymers with styrene/butadiene mass ratio of 85/15 and molecular weights of 24,000 and 125,000 for the styrene blocks (Denki Kagaku Kogyo Clearen 850L)
Resin 4—Resin comprising styrene-butadiene block copolymers with styrene/butadiene mass ratio of 75/25 and molecular weights of 48,000 and 76,000 for the styrene blocks (Denki Kagaku Kogyo Clearen 730L)
Resin 5—Resin comprising styrene-butadiene block copolymers with styrene/butadiene mass ratio of 76/24 and molecular weights of 15,000 and 71,000 for the styrene blocks (Denki Kagaku Kogyo Clearen 210M)
Resin 6—Resin comprising a rubber-modified styrene polymer having styrene monomer units and (meth)acrylic acid ester monomer units wherein the mass ratio of styrene/butadiene/methylmethacrylate/n-butylacrylate is 50.0/6.0/36.5/7.0.

### Examples 1-10

Examples 1-10 respectively use Resin 1 as the GPPS resin (A) and Resin 2 as the HIPS resin (B). Additionally, Resins 3-5 of different styrene/butadiene mass ratios and molecular weights of the styrene blocks were chosen as the resin comprising a styrene-butadiene block copolymer (C), and these were mixed in the blending ratios shown in Table 1 to prepare various resin compositions.

Next, the resin compositions were melt-kneaded in an extruder and extruded from T-dice to obtain an unstretched sheet. Next, this unstretched sheet was stretched 2.3-fold in the vertical direction while heated to 90 to 135° C. using a vertical stretcher, then stretched 2.3-fold in the horizontal direction while heated to 90 to 135° C. using a horizontal stretcher, to obtain biaxially stretched sheets according to Examples 1-10.

Next, the orientation relaxation stress, haze, tensile elasticity, sheet impact and folding strength of the resulting biaxially stretched sheets were measured by the measurement methods described below.

Additionally, the resulting biaxially stretched sheets were slit into strips of tape 32 mm wide. Next, sprocket holes were punched out using conventional methods, then the tape strips were supplied to a press forming machine produced by the applicant company, and heaters equipped with local heating portions were pressed against both surfaces of the tape under the heating conditions shown in Table 1, so as to heat only the portions of the tape where the embossed portions were to be formed.

Subsequently, the heated portions of the tape were advanced to raised portions of the press mold at the positions of the embossed portions to perform press forming, resulting in embossed carrier tapes of Examples 1-10 comprising embossed portions of length (in the longitudinal direction of the tape) 14 mm×width (width direction) 20 mm×depth 13 mm, and sprocket holes.

The state of generation of dust at the sprocket hole portions and the formability during forming were evaluated in accordance with evaluation methods to be described below. The resulting embossed carrier tapes were measured for the buckling strength and heat resistance of the molded articles.

The results are shown together in Table 1.

### Example 11

An unstretched sheet was prepared in the same manner as Example 1, from a resin composition having the same resin composition and resin blending ratio and the same sheet thickness as Example 1. Next, this was stretched 1.5-fold in the vertical direction while heated to 90 to 135° C. using a vertical stretcher, then stretched 1.5-fold in the horizontal direction while heated to 90 to 135° C. using a horizontal stretcher, to obtain a biaxially stretched sheet according to Example 11. Next, an embossed carrier tape was formed in the same manner as Example 1. Evaluations of the various properties such as the physical properties and formability of the sheet were performed in the same manner as Example 1, and the results are shown in Table 1.

### Example 12

An unstretched sheet was prepared in the same manner as Example 1, from a resin composition having the same resin makeup and resin blending ratio and the same sheet thickness as Example 1. Next, this was stretched 4.5-fold in the vertical direction while heated to 90 to 135° C. using a vertical stretcher, then stretched 4.5-fold in the horizontal direction while heated to 90 to 135° C. using a horizontal stretcher, to obtain a biaxially stretched sheet according to Example 12.

Next, an embossed carrier tape was formed in the same manner as Example 1. Evaluations of the various properties such as the physical properties and formability of the sheet were performed in the same manner as Example 1, and the results are shown in Table 1.

### Comparative Example 1

An unstretched sheet was prepared in the same manner as Example 1, from a resin composition having the same resin composition and resin blending ratio and the same sheet thickness as Example 1. Next, this was stretched in the vertical direction using a vertical stretcher, then stretched in the horizontal direction using a horizontal stretcher, to obtain a biaxially stretched sheet according to Comparative Example 1 formed by biaxially stretching in the same manner as Example 1.

Next, various physical properties of the resulting biaxially stretched sheet were measured using the measurement method described below. Additionally, an embossed carrier tape was formed by the same method as the above examples, and its formability was evaluated.

However, in Comparative Example 1, the portions corresponding to the embossed portions were not locally heated. Instead, the entire sheet was heated.

### Comparative Example 2

An unstretched sheet was prepared in the same manner as Example 1, from a resin composition having the same resin composition and resin blending ratio and the same sheet thickness as Example 1. Next, this was stretched 5.8-fold in the vertical direction while heated to 90 to 135° C. using a vertical stretcher, then stretched 5.8-fold in the horizontal direction while heated to 90 to 135° C. using a horizontal stretcher, to obtain a biaxially stretched sheet according to Comparative Example 2.

In Comparative Example 2, the orientation relaxation stress value was 0.9. Next, the various physical properties of the resulting biaxially stretched sheet were measured by a measurement method to be described below. Additionally, an embossed carrier tape was formed by the same method as in the above examples, and their formability was evaluated. The results are shown together in Table 2.

### Comparative Example 3

An unstretched sheet was prepared in the same manner as Example 1, from a resin composition having the same resin composition and resin blending ratio and the same sheet thickness as Example 1 to form a sheet according to Comparative Example 3. Next, the various physical properties of the resulting sheet were measured by a measurement method to be described below. Additionally, an embossed carrier tape was formed by the same method as in the above examples without biaxially stretching the sheet, and the formability thereof was evaluated. The results are shown in Table 2.

### Comparative Example 4

An unstretched sheet was prepared in the same manner as Example 1, from a resin composition having the same resin composition and resin blending ratio and the same sheet thickness as Example 1. Next, this was stretched in the vertical direction using a vertical stretcher, then stretched in the horizontal direction using a horizontal stretcher, to obtain a biaxially stretched sheet according to Comparative Example 4 formed by biaxially stretching in the same manner as Example 1.

Next, various physical properties of the resulting biaxially stretched sheet were measured using the measurement method described below.

In Comparative Example 4, the sheet was formed using a conventional compressed-air forming machine. In this compressed-air forming machine, the entire tape is heated by an infrared heater, then fed to a forming mold portion having a plurality of concave embossment forming portions arranged on a plane and sandwiched by an upper mold having concavities covering the embossment forming portions, then compressed air is supplied from compressed air supply ports having openings in the concavities of the upper mold, thus forming an embossed portion. The results of evaluation of the formability are shown together in Table 2.

Evaluations of the performance of the carrier tape sheet and embossed carrier tape were performed by the following methods.

### 1. Orientation Relaxation Stress

The MD and TD orientation relaxation stresses of the sheets were measured in accordance with ASTM D-1504. MD refers to the sheet winding direction and TD refers to the sheet width direction.

### 2. Haze

The haze of the sheet was measured in accordance with JIS K 7105 using a Nippon Denshoku Haze Meter NDH2000.

### 3. Tensile Elasticity

The tensile elasticity of the sheet was measured in accordance with JIS K 7127 using a tension meter.

### 4. Sheet Impact

The sheet impact strength was measured using a Tester Sangyo Film Impact Tester equipped with a weight of tip shape (R10).

5. Folding Strength

The number of back-and-forth foldings until breakage of a sheet sample was measured in accordance with JIS P8115 using a folding strength measurer.

6. Generation of Dust during Hole Punching Process

The sprocket hole portions of the embossed carrier tape formed by a press molding device of the applicant company were observed by a measuring microscope (Mitsutoyo). With the state of absence of powder as 0%, the proportional area of the dust taking up the sprocket holes was calculated.

### 7. Evaluation of Formability

The carrier tape sheets of each example and comparative example were slit to a width of 32 mm to form an embossed carrier tape having embossed portions of length (in the longitudinal direction of the tape) 14 mm×width (in the width direction) 20 mm×depth 13 mm, and the formability of the sheets was observed by eye. The evaluation of formability was performed in a three-stage evaluation wherein those with good formability were rated ◯, those with unsatisfactory formability but capable of embossment formation were rated Δ and those in which embossment formation was not possible due to the occurrence of holes or sheet contraction were rated X.

### 8. Buckling Strength of Molded Articles

The embossed carrier tapes obtained by molding as described above were compressed from the bottom surfaces of the embossed portions using a tension meter, and the buckling strength at which the embossed portions buckled were measured.

### 9. Heat Resistance of Molded Articles

The embossed carrier tapes obtained by forming as indicated above were measured for the change in the length (80 mm) between 21 sprocket holes opened at intervals of 4 mm, before and after storage for 24 hours in an oven at 60° C. If the change was within 0.3 mm, a rating of ◯ was assigned, and if the change was greater than 0.3 mm, a rating of X was assigned.

TABLE 1

| | Ex. 1 | Ex. 2 | Ex. 3 | Ex. 4 | Ex. 5 | Ex. 6 |
|---|---|---|---|---|---|---|
| Orientation relaxation stress MD/TD | 0.5/0.4 | 0.3/0.3 | 0.5/0.5 | 0.5/0.5 | 0.5/0.5 | 0.5/0.5 |
| Sheet thickness | 0.25 mm | 0.15 mm | 0.5 mm | 0.3 mm | 0.5 mm | 0.25 mm |
| Heating temperature | 160° C. | 150° C. | 180° C. | 100° C. | 130° C. | 160° C. |
| Heating contact time | 0.6 sec | 0.3 sec | 4.5 sec | 1.2 sec | 5 sec | 0.6 sec |
| Local heating portion intervals vs. sheet thickness | 100% | 100% | 100% | 100% | 100% | 95% |
| GPPS (A) | A: 58.5% | A: 58.5% | A: 58.5% | A: 58.5% | A: 58.5% | A: 58.5% |
| HIPS with 4-10% rubber part (B) | B: 1.5% | B: 1.5% | B: 1.5% | B: 1.5% | B: 1.5% | B: 1.5% |
| Styrene-conjugated diene block copolymer (C) | C: 40% | C: 40% | C: 40% | C: 40% | C: 40% | C: 40% |
| Styrene-conjugated diene block copolymer (C) | Resin 3 | Resin 3 | Resin 3 | Resin 3 | Resin 3 | Resin 3 |
| Haze | 1.8 | 1.7 | 1.9 | 1.8 | 1.9 | 1.9 |
| Tensile elasticity | 2.7/2.8 | 2.6/2.5 | 2.7/2.8 | 2.6/2.7 | 2.7/2.8 | 2.7/2.8 |
| Sheet impact strength | 6800 | 4500 | 7200 | 6300 | 7200 | 6800 |
| Folding strength | 79/128 | 148/218 | 83/123 | 83/141 | 83/123 | 79/128 |
| Dust | 3.3 | 3 | 3.6 | 3.2 | 3.6 | 3.3 |
| Formability | ◯ | ◯ | ◯ | ◯ | ◯ | ◯ |
| Buckling strength | 28.9 | 22.1 | 30.8 | 29.1 | 30.7 | 29.1 |
| Molded article heat resistance | ◯ | ◯ | ◯ | ◯ | ◯ | ◯ |
| | Ex. 7 | Ex. 8 | Ex. 9 | Ex. 10 | Ex. 11 | Ex. 12 |
| Orientation relaxation stress MD/TD | 0.5/0.4 | 0.3/0.4 | 0.4/0.5 | 0.5/0.4 | 0.2/0.2 | 0.7/0.6 |
| Sheet thickness | 0.25 mm | 0.25 mm | 0.25 mm | 0.25 mm | 0.25 mm | 0.25 mm |
| Heating temperature | 160° C. | 160° C. | 160° C. | 160° C. | 160° C. | 160° C. |
| Heating contact time | 0.6 sec | 0.6 sec | 0.6 sec | 0.6 sec | 0.6 sec | 0.6 sec |
| Local heating portion intervals vs. sheet thickness | 100% | 100% | 100% | 100% | 100% | 95% |
| GPPS (A) | A: 19% | A: 49% | A: 58.5% | A: 98.5% | A: 58.5% | A: 58.5% |
| HIPS with 4-10% rubber part (B) | B: 1.0% | B: 1.0% | B: 1.5% | B: 1.5% | B: 1.5% | B: 1.5% |
| Styrene-conjugated diene block copolymer (C) | C: 80% | C: 50% | C: 40% | C: 0% | C: 40% | C: 40% |
| Styrene-conjugated diene block copolymer (C) | Resin 3 | Resin 4 | Resin 5 | — | Resin 3 | Resin 3 |
| Haze | 2.1 | 4.1 | 3.8 | 2.1 | 1.6 | 1.7 |
| Tensile elasticity | 2.0/2.0 | 2.4/2.3 | 2.3/2.4 | 3.1/3.1 | 2.6/2.7 | 2.7/2.7 |
| Sheet impact strength | 9800 | 7200 | 5900 | 4800 | 5100 | 7300 |
| Folding strength | 290/432 | 353/298 | 72/89 | 28/13 | 63/121 | 95/131 |
| Dust | 3.4 | 3.9 | 3.4 | 4.9 | 3.3 | 3.6 |
| Formability | ◯ | ◯ | ◯ | ◯ | ◯ | ◯ |
| Buckling strength | 19.1 | 18.4 | 19.5 | 25.3 | 12.4 | 14.9 |
| Molded article heat resistance | ◯ | ◯ | ◯ | ◯ | ◯ | ◯ |

TABLE 2

| | Comp. Ex. 1 | Comp. Ex. 2 | Comp. Ex. 3 | Comp. Ex. 4 |
|---|---|---|---|---|
| Biaxial stretching | ◯ | ◯ | X (unstretched) | ◯ |
| Local heating of cavity-corresponding portions | X (full heating) | ◯ | ◯ | ◯ |
| Press forming | ◯ | ◯ | ◯ | X (compressed-air) |
| Orientation relaxation stress MD/TD | 0.5/0.4 | 0.9/0.9 | 0.1/0.1 | 0.5/0.4 |
| Sheet thickness | 0.25 mm | 0.25 mm | 0.25 mm | 0.25 mm |
| Heating temperature | 160° C. | 160° C. | 160° C. | 160° C. |
| Heating contact time | 0.6 sec | 0.6 sec | 0.6 sec | 0.6 sec |
| Local heating portion intervals vs. sheet thickness | 100% | 100% | 100% | 100% |
| GPPS (A) | A: 58.5% | A: 58.5% | A: 58.5% | A: 58.5% |
| HIPS with 4-10% rubber part (B) | B: 1.5% | B: 1.5% | B: 1.5% | B: 1.5% |
| Styrene-conjugated diene block copolymer (C) | C: 40% | C: 40% | C: 40% | C: 40% |
| Styrene-conjugated diene block copolymer (C) | Resin 3 | Resin 3 | Resin 3 | Resin 3 |
| Haze | 1.8 | 2.1 | 1.7 | 1.8 |
| Tensile elasticity | 2.7/2.8 | 2.8/2.9 | 2.5/2.4 | 2.7/2.8 |
| Sheet impact strength | 6800 | 7200 | 4400 | 6800 |
| Folding strength | 79/128 | 15/23 | 19/32 | 79/128 |
| Dust | — | — | 5.2 | — |
| Formability | X | X | Δ | X |
| Buckling strength | — | — | 5.3 | — |
| Molded article heat resistance | — | — | X | — |

As is clear from the results in the above tables, embossed carrier tapes obtained by forming biaxially stretched sheets according to Examples 1-12 by locally heating them while controlling the heating temperature and heating time to predetermined ranges, the sheets being produced from resin compositions comprising predetermined amounts of a GPPS resin (A), a HIPS resin (B) and in some cases a styrene-butadiene block copolymer (C), with the sheet thickness and orientation relaxation stress values controlled to predetermined ranges, excel in haze (transparency), tensile elasticity, sheet impact strength and folding strength, and also excel in formability and buckling strength of the embossed portions of the molded articles, as well as suppressing the generation of dust during hole formation.

### Examples 1-8

Next, experimental examples of the biaxially stretched sheet of Example 1 shall be described for cases in which the sheet thickness, heating temperature of the local heating, contact time during local heating and spacing between local heating portions were changed.

TABLE 3

| | Exp. Ex. 1 | Exp. Ex. 2 | Exp. Ex. 3 | Exp. Ex. 4 |
|---|---|---|---|---|
| Orientation relaxation stress MD/TD | 0.3/0.3 | 0.5/0.6 | 0.5/0.4 | 0.5/0.4 |
| Sheet thickness | 0.12 mm | 0.6 mm | 0.25 mm | 0.25 mm |
| Heating temperature | 110° C. | 180° C. | 90° C. | 200° C. |
| Heating contact time | 0.25 sec | 7.5 sec | 5 sec | 0.3 sec |
| Local heating portion intervals vs. sheet thickness | 100% | 100% | 100% | 100% |
| GPPS (A) | A: 58.5% | A: 58.5% | A: 58.5% | A: 58.5% |
| HIPS with 4-10% rubber part (B) | B: 1.5% | B: 1.5% | B: 1.5% | B: 1.5% |
| Styrene-conjugated diene block copolymer (C) | C: 40% | C: 40% | C: 40% | C: 40% |
| Styrene-conjugated diene block copolymer (C) | Resin 3 | Resin 3 | Resin 3 | Resin 3 |
| Haze | 1.7 | 2 | 1.8 | 1.8 |
| Tensile elasticity | 2.6/2.5 | 2.8/2.8 | 2.7/2.8 | 2.7/2.8 |
| Sheet impact strength | 4200 | 7700 | 6800 | 6800 |
| Folding strength | 135/197 | 77/115 | 79/128 | 79/128 |
| Dust | 4.8 | 5.5 | — | — |
| Formability | Δ | Δ | X | X |
| Buckling strength | 15.3 | 31.2 | — | — |
| Molded article heat resistance | X | X | — | — |
| | Exp. Ex. 5 | Exp. Ex. 6 | Exp. Ex. 7 | Exp. Ex. 8 |
| Orientation relaxation stress MD/TD | 0.3/0.3 | 0.5/0.5 | 0.5/0.4 | 0.5/0.4 |
| Sheet thickness | 0.15 mm | 0.5 mm | 0.25 mm | 0.25 mm |
| Heating temperature | 180° C. | 130° C. | 160° C. | 160° C. |
| Heating contact time | 0.2 sec | 6 sec | 0.6 sec | 0.6 sec |
| Local heating portion intervals vs. sheet thickness | 100% | 100% | 90% | 100% |
| GPPS (A) | A: 58.5% | A: 58.5% | A: 58.5% | A: 58.5% |
| HIPS with 4-10% rubber part (B) | B: 1.5% | B: 1.5% | B: 1.5% | B: 1.5% |
| Styrene-conjugated diene block copolymer (C) | C: 40% | C: 40% | C: 40% | C: 40% |
| Styrene-conjugated diene block copolymer (C) | Resin 3 | Resin 3 | Resin 3 | Resin 3 |
| Haze | 1.7 | 1.9 | 1.8 | 1.8 |
| Tensile elasticity | 2.6/2.5 | 2.7/2.8 | 2.7/2.8 | 2.7/2.8 |
| Sheet impact strength | 4500 | 7200 | 6800 | 6800 |
| Folding strength | 148/218 | 83/123 | 79/128 | 79/128 |
| Dust | — | — | 3.2 | 3.4 |
| Formability | X | X | Δ | Δ |
| Buckling strength | — | — | 25.3 | 20 |
| Molded article heat resistance | — | — | ◯ | ◯ |

The above tables show that the properties of the resulting carrier tape can be affected by the sheet thickness and various conditions during local heating of the sheet.

### Examples 13-20

Using Resin 1 as the GPPS resin (A) and Resin 2 as the HIPS resin (B), and choosing Resins 3-5 of different styrene/butadiene mass ratio and styrene block molecular weights as the resin containing a styrene-butadiene block copolymer (C), these were mixed in the blending ratios shown in Table 4 to prepare various resin compositions.

Next, the resin compositions were melt-kneaded in an extruder, then extruded from T-dice to obtain an unstretched sheet. Next, this unstretched sheet was stretched 2.3-fold in the vertical direction while heated to 90 to 135° C. using a vertical stretcher, then stretched 2.3-fold in the horizontal direction while heated to 90 to 135° C. using a horizontal stretcher, to obtain biaxially stretched sheets according to Examples 13-20.

Next, the orientation relaxation stress, haze, tensile elasticity, sheet impact and folding strength of the resulting biaxially stretched sheets were measured by the measurement methods described below.

Additionally, the resulting biaxially stretched sheets were slit into strips of tape 16 mm wide. Next, the tape was fed to a rotary vacuum forming machine produced by the applicant company, equipped with a cylindrical heater having local heating portions and a cylindrical forming mod having embossment forming portions, and sprocket holes were punched out after thermoforming under the conditions shown in Table 4, resulting in an embossed carrier tape with embossed portions of length (in the longitudinal direction of the tape) 3 mm×width (in the width direction) 2 mm×depth 1.5 mm, and sprocket holes.

In order to form embossments at the locally heated portions of the tape, a heater having local heating portions of roughly the same shape as the embossed portions arranged at a uniform spacing on the outer circumference of the cylinder and a forming mold having embossment forming portions arranged at a uniform spacing on the outer circumference of the cylinder were rotated in synchronization.

The formability and buckling strength of the embossed carrier tape were evaluated in accordance with the evaluation methods described below, and the state of generation of dust in the sprocket hole portions and heat resistance of the molded articles were assessed. The results are shown together in Table 4.

### Example 21

An unstretched sheet was prepared in the same manner as Example 13, from a resin composition having the same resin composition and resin blending ratio and the same sheet thickness as Example 13.

Next, this was stretched 1.5-fold in the vertical direction while heated to 90 to 135° C. using a vertical stretcher, then stretched 1.5-fold in the horizontal direction while heated to 90 to 135° C. using a horizontal stretcher, to obtain a biaxially stretched sheet according to Example 21.

Next, the various physical properties of the resulting sheets were measured by the measurement methods described below. Additionally, they were formed into embossed carrier tapes by the same methods as Examples 13-20, and their formability was evaluated. The results are shown in Table 4.

### Example 22

An unstretched sheet was prepared in the same manner as Example 13, from a resin composition having the same resin makeup and resin blending ratio and the same sheet thickness as Example 13.

Next, this was stretched 4.5-fold in the vertical direction while heated to 90 to 135° C. using a vertical stretcher, then stretched 4.5-fold in the horizontal direction while heated to 90 to 135° C. using a horizontal stretcher, to obtain a biaxially stretched sheet according to Example 22.

Next, the various physical properties of the resulting sheets were measured by the measurement methods described below. Additionally, they were formed into embossed carrier tapes by the same methods as Examples 13-20, and their formability was evaluated. The results are shown in Table 4.

### Comparative Example 5

An unstretched sheet was prepared in the same manner as Example 13, from a resin composition having the same resin composition and resin blending ratio and the same sheet thickness as Example 13. Next, this was stretched in the vertical direction using a vertical stretcher, then stretched in the horizontal direction using a horizontal stretcher in the same manner as Example 13, to obtain a biaxially stretched sheet according to Comparative Example 5.

Additionally, embossed carrier tapes were formed by the same method as Example 13, and the various physical properties were measured. The results are shown in Table 5. However, in Comparative Example 5, the tape was not locally heated at only the portions corresponding to the embossed portions, but instead, the entire tape was heated using a heater of a shape lacking the local heating portions on the heater.

### Comparative Example 6

An unstretched sheet was prepared in the same manner as Example 13, from a resin composition having the same resin composition and resin blending ratio and the same sheet thickness as Example 13. Next, the various physical properties of the resulting sheet were measured by measurement methods to be described below.

Additionally, an embossed carrier tape was formed by the same method as Example 13, and its formability was evaluated. The results are shown in Table 5. In Comparative Example 6, the sheet was not stretched.

### Comparative Example 7

An unstretched sheet was prepared in the same manner as Example 13, from a resin composition having the same resin composition and resin blending ratio and the same sheet thickness as Example 13. Next, this was stretched in the vertical direction using a vertical stretcher, then stretched in the horizontal direction using a horizontal stretcher in the same manner as Example 13, to obtain a biaxially stretched sheet according to Comparative Example 7.

Next, the various physical properties of the resulting sheet were measured by measurement methods to be described below.

In Comparative Example 7, the sheet was formed using a conventional compressed-air forming machine. In this compressed-air forming machine, the entire tape was heated by an infrared heater, then fed to a forming mold portion having a plurality of concave embossment forming portions arranged on a plane and sandwiched by an upper mold having concavities covering the embossment forming portions, then compressed air was supplied from compressed air supply ports having openings in the concavities of the upper mold, thus forming an embossed portion. The results of evaluation of the formability are shown together in Table 5.

Evaluations of the performance of the carrier tape sheet and embossed carrier tape were performed by the following methods.

### 1. Orientation Relaxation Stress

The MD and TD orientation relaxation stresses of the sheets were measured in accordance with ASTM D-1504. MD refers to the sheet winding direction and TD refers to the sheet width direction.

### 2. Haze

The haze of the sheet was measured in accordance with JIS K 7105 using a Nippon Denshoku Haze Meter NDH2000.

### 3. Tensile Elasticity

The tensile elasticity of the sheet was measured in accordance with JIS K 7127 using a tension meter.

### 4. Sheet Impact

The sheet impact strength was measured using a Tester Sangyo Film Impact Tester equipped with a weight of tip shape (R10).

### 5. Folding Strength

The number of back-and-forth foldings until breakage of a sheet sample was measured in accordance with JIS P8115 using a folding strength measurer.

6. Generation of Dust during Hole Punching Process

The sprocket hole portions of the embossed carrier tape formed by a press molding device of the applicant company were observed by a measuring microscope (Mitsutoyo). With the state of absence of powder as 0%, the proportional area of the dust taking up the sprocket holes was calculated.

### 7. Evaluation of Formability

The carrier tape sheets of each example and comparative example were slit to a width of 16 mm to form an embossed carrier tape having embossed portions of length (in the longitudinal direction of the tape) 3 mm×width (in the width direction) 2 mm×depth 1.5 mm, and the formability of the sheets was observed by eye. The evaluation of formability was performed in a three-stage evaluation wherein those with good formability were rated ◯, those with unsatisfactory formability but capable of embossment formation were rated Δ and those in which embossment formation was not possible due to the occurrence of holes or sheet contraction were rated X.

### 8. Buckling Strength of Molded Articles

The embossed carrier tapes obtained by molding as described above were compressed from the bottom surfaces of the embossed portions using a tension meter, and the buckling strength at which the embossed portions buckled were measured.

9. Heat Resistance of Molded Articles

The embossed carrier tapes obtained by forming as indicated above were measured for the change in the length (80 mm) between 21 sprocket holes opened at intervals of 4 mm, before and after storage for 24 hours in an oven at 60° C. If the change was within 0.3 mm, a rating of ◯ was assigned, and if the change was greater than 0.3 mm, a rating of X was assigned.

TABLE 4

| | Ex. 13 | Ex. 14 | Ex. 15 | Ex. 16 | Ex. 17 |
|---|---|---|---|---|---|
| Synchronization | ◯ | ◯ | ◯ | ◯ | ◯ |
| Sheet thickness | 0.25 mm | 0.15 mm | 0.5 mm | 0.3 mm | 0.25 mm |
| Heating temperature | 170° C. | 160° C. | 180° C. | 110° C. | 170° C. |
| Heating contact time | 1.0 sec | 0.5 sec | 6.0 sec | 2.0 sec | 1.05 sec |
| Orientation relaxation stress MD/TD | 0.5/0.4 | 0.3/0.3 | 0.5/0.5 | 0.5/0.5 | 0.5/0.4 |
| GPPS (A) | A: 58.5% | A: 58.5% | A: 58.5% | A: 58.5% | A: 19% |
| HIPS with 4-10% rubber part (B) | B: 1.5% | B: 1.5% | B: 1.5% | B: 1.5% | B: 1.0% |
| Styrene-conjugated diene block copolymer (C) | C: 40% | C: 40% | C: 40% | C: 40% | C: 80% |
| Styrene-conjugated diene block copolymer (C) | Resin 3 | Resin 3 | Resin 3 | Resin 3 | Resin 3 |
| Haze | 1.8 | 1.7 | 1.9 | 1.8 | 2.1 |
| Tensile elasticity | 2.7/2.8 | 2.6/2.5 | 2.7/2.8 | 2.6/2.7 | 2.0/2.0 |
| Sheet impact strength | 6800 | 4500 | 7200 | 6300 | 9800 |
| Folding strength | 79/128 | 148/218 | 83/123 | 83/141 | 290/432 |
| Dust | 3.1 | 3.1 | 3.5 | 3.3 | 3.4 |
| Formability | ◯ | ◯ | ◯ | ◯ | ◯ |
| Buckling strength | 28.9 | 22.1 | 30.8 | 29.1 | 19.1 |
| Molded article heat resistance | ◯ | ◯ | ◯ | ◯ | ◯ |
| | Ex. 18 | Ex. 19 | Ex. 20 | Ex. 21 | Ex. 22 |
| Synchronization | ◯ | ◯ | ◯ | ◯ | ◯ |
| Sheet thickness | 0.25 mm | 0.25 mm | 0.25 mm | 0.25 mm | 0.25 mm |
| Heating temperature | 170° C. | 170° C. | 170° C. | 170° C. | 170° C. |
| Heating contact time | 1.0 sec | 1.0 sec | 1.0 sec | 1.0 sec | 1.0 sec |
| Orientation relaxation stress MD/TD | 0.3/0.4 | 0.4/0.5 | 0.5/0.4 | 0.2/0.2 | 0.7/0.6 |
| GPPS (A) | A: 49% | A: 58.5% | A: 98.5% | A: 58.5% | A: 58.5% |
| HIPS with 4-10% rubber part (B) | B: 1.0% | B: 15% | B: 1.5% | B: 1.5% | B: 1.5% |
| Styrene-conjugated diene block copolymer (C) | C: 50% | C: 40% | C: 0% | C: 40% | C: 40% |
| Styrene-conjugated diene block copolymer (C) | Resin 4 | Resin 5 | — | Resin 3 | Resin 3 |
| Haze | 4.1 | 3.8 | 2.1 | 1.6 | 1.7 |
| Tensile elasticity | 2.4/2.3 | 2.3/2.4 | 3.1/3.1 | 2.6/2.7 | 2.7/2.7 |
| Sheet impact strength | 7200 | 5900 | 4800 | 5100 | 7300 |
| Folding strength | 353/298 | 72/89 | 28/13 | 63/121 | 95/131 |
| Dust | 3.7 | 3.3 | 4.6 | 3.1 | 3.5 |
| Formability | ◯ | ◯ | ◯ | ◯ | ◯ |
| Buckling strength | 18.4 | 19.5 | 25.3 | 12.4 | 14.9 |
| Molded article heat resistance | ◯ | ◯ | ◯ | ◯ | ◯ |

TABLE 5

| | Comp. Ex. 5 | Comp. Ex. 7 | Comp. Ex. 4 |
|---|---|---|---|
| Biaxial stretching | ◯ | X (unstretched) | X |
| Local heating of cavity-corresponding portions | X (full heating) | ◯ | conventional |
| Press forming | ◯ | ◯ | compressed-air |
| Synchronization | — | ◯ | |
| Sheet thickness | 0.25 mm | 0.25 mm | 0.25 mm |
| Heating temperature | 170° C. | 170° C. | 170° C. |
| Heating contact time | 1.0 sec | 1.0 sec | 1.0 sec |
| Orientation relaxation stress MD/TD | 0.5/0.4 | 0.1/0.1 | 0.5/0.4 |
| GPPS (A) | A: 58.5% | A: 58.5% | A: 58.5% |
| HIPS with 4-10% rubber part (B) | B: 1.5% | B: 1.5% | B: 1.5% |
| Styrene-conjugated diene block copolymer (C) | C: 40% | C: 40% | C: 40% |
| Styrene-conjugated diene block copolymer (C) | Resin 3 | Resin 3 | Resin 3 |
| Haze | 1.8 | 1.7 | 1.8 |
| Tensile elasticity | 2.7/2.8 | 2.5/2.4 | 2.7/2.8 |
| Sheet impact strength | 6800 | 4400 | 6800 |
| Folding strength | 79/128 | 19/32 | 79/128 |
| Dust | — | 5.4 | — |
| Formability | X | Δ | X |
| Buckling strength | — | 5.3 | — |
| Molded article heat resistance | — | X | — |

As is clear from the results in the above tables, embossed carrier tapes obtained by forming biaxially stretched sheets according to Examples 13-22 by locally heating them while controlling the heating temperature and heating time to predetermined ranges, the sheets being produced from resin compositions comprising predetermined amounts of a GPPS resin (A), a HIPS resin (B) and in some cases a styrene-butadiene block copolymer (C), with the sheet thickness and orientation relaxation stress values controlled to predetermined ranges, excel in haze (transparency), tensile elasticity, sheet impact strength and folding strength, and also excel in formability and buckling strength of the embossed portions of the molded articles, as well as suppressing the generation of dust during hole formation.

### Experimental Examples 9-18

Next, experimental examples wherein the biaxially stretched sheet of Example 13 was subjected to changes in the resin composition, sheet thickness, heating temperature of the local heating of the tape, contact time of the local heating of the tape, and the orientation relaxation stress are shown. In Experimental Example 18, the resin composition was prepared using only Resin 6.

TABLE 6

| | Exp. Ex. 9 | Exp. Ex. 10 | Exp. Ex. 11 | Exp. Ex. 12 | Exp. Ex. 13 |
|---|---|---|---|---|---|
| Synchronization | X | ◯ | ◯ | ◯ | ◯ |
| Sheet thickness | 0.25 mm | 0.12 mm | 0.6 mm | 0.25 mm | 0.25 mm |
| Heating temperature | 170° C. | 110° C. | 180° C. | 100° C. | 190° C. |
| Heating contact time | 1.0 sec | 0.5 sec | 6 sec | 6 sec | 0.3 sec |
| Orientation relaxation stress MD/TD | 0.5/0.4 | 0.3/0.3 | 0.5/0.6 | 0.5/0.4 | 0.5/0.4 |
| GPPS (A) | A: 58.5% | A: 58.5% | A: 58.5% | A: 58.5% | A: 58.5% |
| HIPS with 4-10% rubber part (B) | B: 1.5% | B: 1.5% | B: 1.5% | B: 1.5% | B: 1.5% |
| Styrene-conjugated diene block copolymer (C) | C: 40% | C: 40% | C: 40% | C: 40% | C: 40% |
| Styrene-conjugated diene block copolymer (C) | Resin 3 | Resin 3 | Resin 3 | Resin 3 | Resin 3 |
| Haze | 1.8 | 1.7 | 2 | 1.8 | 1.8 |
| Tensile elasticity | 2.7/2.8 | 2.6/2.5 | 2.8/2.8 | 2.7/2.8 | 2.7/2.8 |
| Sheet impact strength | 6800 | 4200 | 7700 | 6800 | 6800 |
| Folding strength | 79/128 | 135/197 | 77/115 | 79/128 | 79/128 |
| Dust | — | — | — | — | — |
| Formability | X | X | X | X | X |
| Buckling strength | — | — | — | — | — |
| Molded article heat resistance | — | — | — | — | — |
| | Exp. Ex. 14 | Exp. Ex. 15 | Exp. Ex. 16 | Exp. Ex. 17 | Exp. Ex. 18 |
| Synchronization | ◯ | ◯ | ◯ | ◯ | ◯ |
| Sheet thickness | 0.15 mm | 0.5 mm | 0.25 mm | 0.25 mm | 0.25 mm |
| Heating temperature | 180° C. | 130° C. | 170° C. | 170° C. | 170° C. |
| Heating contact time | 0.3 sec | 7 sec | 1.0 sec | 1.0 sec | 1.0 sec |
| Orientation relaxation stress MD/TD | 0.3/0.3 | 0.5/0.5 | 0.9/0.9 | 0.3/0.4 | 0.1/0.1 |
| GPPS (A) | A: 58.5% | A: 58.5% | A: 58.5% | A: 4.5% | A: 0% |
| HIPS with 4-10% rubber part (B) | B: 1.5% | B: 15% | B: 1.5% | B: 1.5% | B: 0% |
| Styrene-conjugated diene block copolymer (C) | C: 40% | C: 40% | C: 40% | C: 94% | C: 100% |
| Styrene-conjugated diene block copolymer (C) | Resin 3 | Resin 3 | Resin 3 | Resin 3 | Resin 6 |
| Haze | 1.7 | 1.9 | 2.1 | 2.3 | 8.6 |
| Tensile elasticity | 2.6/2.5 | 2.7/2.8 | 2.8/2.9 | 2.0/2.0 | 1.7/1.6 |
| Sheet impact strength | 4500 | 7200 | 7200 | 12200 | 13500 |
| Folding strength | 148/218 | 83/123 | 15/23 | 311/494 | 19/16 |
| Dust | — | — | — | 3.6 | 7.5 |
| Formability | X | X | X | Δ | Δ |
| Buckling strength | — | — | — | 8.9 | 5.1 |
| Molded article heat resistance | — | — | — | X | X |

The above table shows that the properties of the resulting carrier tape are affected by resin composition, sheet thickness and various conditions during local heating of the tape.

1. A method of producing an embossed carrier tape, comprising steps of:
(a) slitting a sheet formed by biaxially stretching a styrene resin composition, having an orientation relaxation stress of 0.2 to 0.8 MPa measured in accordance with ASTM D-1504, into tape form;
(b) heating only areas of the slitted tape on which embossed portions are to be formed; and
(c) forming embossed portions at the heated areas.

2. The method of producing an embossed carrier tape according to claim 1, wherein step (c) comprises forming embossed portions at the heated areas by press-forming.

3. The method of producing an embossed carrier tape according to claim 2, wherein step (b) comprises locally heating tape composed of a biaxially stretched sheet of sheet thickness 0.15 to 0.5 mm by bringing it into contact, for 0.3 to 5.0 seconds, with local heating portions heated to 100 to 180° C. having contact surfaces of shapes corresponding to the areas where the embossed portions are to be formed.

4. The method of producing an embossed carrier tape according to claim 3, wherein step (b) comprises positioning the tape between a pair of opposing local heating portions, such that the spacing between the contact surfaces of the opposing local heating portions is 95 to 100% of the sheet thickness.

5. The method of producing an embossed carrier tape according to claim 3 or 4, wherein the surface area of the contact surfaces of the local heating portions is 90 to 110% of the surface area of the areas where the embossed portions are to be formed.

6. The method of producing an embossed carrier tape according to claim 1, wherein:
step (b) comprises consecutively heating only areas of the slitted tape where embossed portions are to be formed, using a rotating cylindrical heater having local heating portions for heating areas of the tape where the embossed portions are to be formed disposed on the outer circumference of a cylinder, in order to form the embossed portions at the heated areas of the tape; and
step (c) comprises consecutively forming the embossed portions at the heated areas using a cylindrical rotary vacuum forming mold that rotates in synchronization with the heater, having embossment forming portions disposed on an outer circumference of the cylinder, where the tape is subjected to evacuation to form the embossed portions.

7. The method of producing an embossed carrier tape according to any one of claims 1 to 6, wherein the styrene resin composition comprises 7 to 79.5 mass % of a polystyrene resin (A); 0.5 to 3 mass % of a high-impact polystyrene resin (B) comprising 4 to 10 mass % of a rubber component; and 20 to 90 mass % of a styrene-conjugated diene block copolymer (C) wherein the molecular weight of the styrene block portion is at least 10,000 and less than 130,000.

8. The method of producing an embossed carrier tape according to claim 7, wherein the styrene-conjugated diene block copolymer (C) is a copolymer comprising 70 to 90 mass % styrene and 10 to 30 mass % conjugated diene.

9. An embossed carrier tape formed by slitting a sheet formed by biaxially stretching a styrene resin composition, having an orientation relaxation stress of 0.2 to 0.8 MPa measured in accordance with ASTM D-1504, into tape form; heating only areas of the slitted tape on which embossed portions are to be formed; then forming embossed portions.

10. The embossed carrier tape according to claim 9, wherein the embossed portions are formed by press-forming.

11. The embossed carrier tape according to claim 10, formed by heating tape composed of a biaxially stretched sheet with a sheet thickness of 0.15 to 0.5 mm slitted into tape form by bringing it into contact, for 0.3 to 5.0 seconds, with local heating portions of a heater at 100 to 180° C. having contact surfaces of shapes corresponding to the areas where the embossed portions are to be formed.

12. The embossed carrier tape according to claim 11, formed by positioning the tape between a pair of opposing local heating portions, such that the spacing between the contact surfaces of the opposing local heating portions is 95 to 100% of the sheet thickness.

13. The embossed carrier tape according to claim 11 or 12, wherein the surface area of the contact surfaces of the local heating portions is 90 to 110% of the surface area of the areas where the embossed portions are to be formed.

14. The embossed carrier tape according to claim 9, wherein only areas of the slitted tape where embossed portions are to be formed are consecutively heated using a rotating cylindrical heater having local heating portions for heating areas of the tape where the embossed portions are to be formed disposed on the outer circumference of a cylinder, in order to form the embossed portions at the heated areas of the tape; and the embossed portions are consecutively formed at the heated areas using a cylindrical rotary vacuum forming mold that rotates in synchronization with the heater, having embossment forming portions disposed on an outer circumference of the cylinder, where the tape is subjected to evacuation to form embossed portions.

15. The embossed carrier tape according to any one of claims 9 to 14, wherein the styrene resin composition comprises 7 to 79.5 mass % of a polystyrene resin (A); 0.5 to 3 mass % of a high-impact polystyrene resin (B) comprising 4 to 10 mass % of a rubber component; and 20 to 90 mass % of a styrene-conjugated diene block copolymer (C) wherein the molecular weight of the styrene block portion is at least 10,000 and less than 130,000.

16. The embossed carrier tape according to claim 15, wherein the styrene-conjugated diene block copolymer (C) is a copolymer comprising 70 to 90 mass % styrene and 10 to 30 mass % conjugated diene.
